(19) United States
(12) Patent Application Publication
(10) Pub. No.: US 2021/0255535 A1
(43) Pub. Date: Aug. 19, 2021

(54) GEAR DRIVE MECHANISM, DIMMING DEVICE, AND PROJECTOR

(71) Applicant: Panasonic Intellectual Property Management Co., Ltd., Osaka (JP)

(72) Inventors: Ya CHEN, Guangdong (CN); Chen CHEN, Guangdong (CN)

(21) Appl. No.: 17/167,369

(22) Filed: Feb. 4, 2021

(30) Foreign Application Priority Data
Feb. 18, 2020 (CN) 202010100598.7

(51) Int. Cl. G03B 21/20; F16H 1/20

(52) U.S. Cl. CPC G03B 21/2053; F16H 1/206

(57) ABSTRACT

A gear drive mechanism includes: a motor; a transmission member provided on a rotating shaft of the motor; a support plate that has a support plate surface, and to which the motor is attached to cause the transmission member to intersect with the support plate surface in a diagonal direction; a first gear that has first helical teeth that mesh with the transmission member and is rotatably attached to the support plate, the first gear rotating in a first direction by rotation of the motor; and a second gear that has second helical teeth and is rotatably attached to the support plate, the second gear rotating in synchronization with rotation of the first gear in a second direction opposite to the first direction.

### BACKGROUND

### 1. Technical Field

The present disclosure relates to a gear drive mechanism, a dimming device including the gear drive mechanism, and a projector including the dimming device.

### 2. Description of the Related Art

As a dimming device having a gear drive mechanism, PTL 1 (Unexamined Japanese Patent Publication No. 2013-171111) discloses the following configuration. In PTL 1, light-shielding plates and gears are provided on both sides of a support plate, and a worm and a motor are provided on the side of the support plate where the gears are provided, and the worm is attached to a rotating shaft provided in parallel to a support plate surface of the motor, and rotating the worm by rotation of the motor allows the gears that mesh with the worm to be rotated. Further, in PTL 1, to transmit the rotation of the gears to the light-shielding plates and adjust an amount of light flux from a light source device, rotation transmitting members are connected to the gears and the light-shielding plates on the side of the support plate where the light-shielding plates are provided. Thereby, when the gears are rotated, the rotation of the gears is transmitted to the light-shielding plates via the rotation transmitting members, and the light-shielding plates are rotated to adjust the amount of light flux.

However, above-described PTL 1 has the following technical problems. Since the worm, the motor, and the gears are disposed on the one side of the support plate, it is necessary to secure a disposition space for these on the one side of the support plate, and there is a technical problem that the gear drive mechanism becomes large. In addition, since it is necessary to provide the rotation transmitting members for transmitting the rotation of the gears to the light-shielding plates, there is a technical problem that a number of parts of the gear drive mechanism is large, and this increases a cost of the gear transmission mechanism, so that there is a technical problem that reduction in weight is difficult, and operating accuracy is low.

### SUMMARY

The present disclosure has been made to solve the above-described technical problems, and an object of the present disclosure is to provide a gear drive mechanism capable of reducing a volume of the gear drive mechanism and reducing a number of parts, a dimming device including the gear drive mechanism, and a projector including the dimming device.

In order to achieve the above object, the present disclosure provides a gear drive mechanism including: a motor; a transmission member provided on a rotating shaft of the motor; a support plate that has a support plate surface, and to which the motor is attached to cause the transmission member to intersect with the support plate surface in a diagonal direction; a first gear that has first helical teeth that mesh with the transmission member and is rotatably attached to the support plate, the first gear rotating in a first direction by rotation of the motor; and a second gear that has second helical teeth and is rotatably attached to the support plate, the second gear rotating in synchronization with rotation of the first gear in a second direction opposite to the first direction.

According to the gear drive mechanism of the present disclosure, since the transmission member intersects with the support plate surface in the diagonal direction to drive the first gear, a volume of the gear drive mechanism can be reduced and a number of parts can be reduced. This makes it possible to reduce a weight and a cost of the gear drive mechanism and improve operating accuracy of the gear drive mechanism.

### BRIEF DESCRIPTION OF THE DRAWINGS

FIG. 1 is an exploded perspective view of a dimming device (gear drive mechanism) of the present disclosure;

FIG. 2 is a perspective view of the gear drive mechanism of the present disclosure;

FIG. 3 is a perspective view of the dimming device of the present disclosure, showing a state where a first blade member and a second blade member are fully open;

FIG. 4 is a perspective view of the dimming device of the present disclosure, showing a state where the first blade member and the second blade member are fully closed;

FIG. 5 is a perspective view of the dimming device seen from a back side of FIG. 4;

FIG. 6 is a front view of the dimming device seen from a front side of FIG. 4;

FIG. 7 is a bottom view of an optical block of a projector of the present disclosure; and

FIG. 8 is a flowchart showing operation of the projector shown in FIG. 7.

### DETAILED DESCRIPTION

Hereinafter, a structure and a function of each portion of the present disclosure will be described in detail with reference to the drawings. In the following description, the same or corresponding members and structures are designated by the same reference numerals, and duplicated description will be omitted.

### Exemplary Embodiment

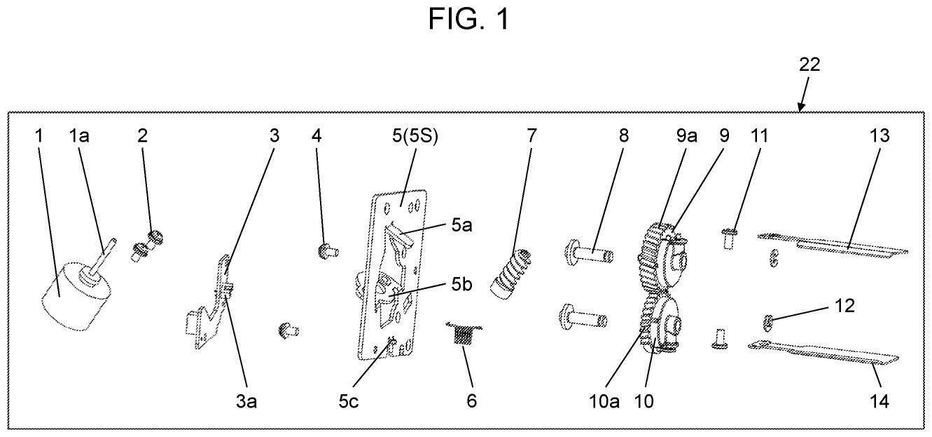

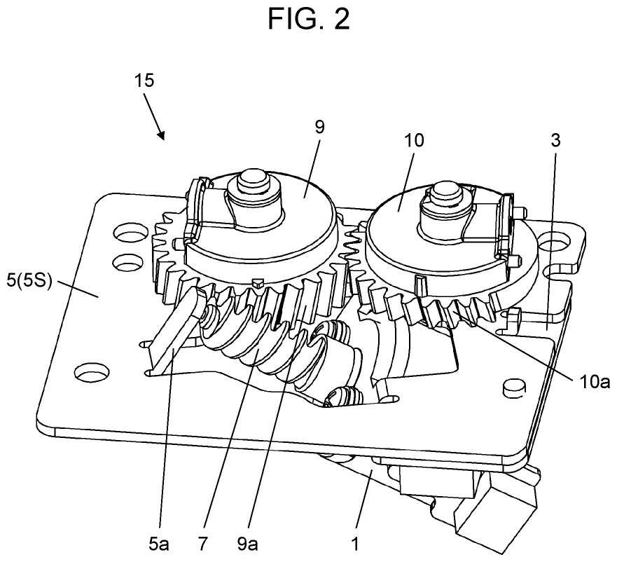

As shown in FIGS. 1 and 2, gear drive mechanism 15 of the present disclosure includes motor 1, transmission member 7 provided on rotating shaft 1a of motor 1, support plate 5 that motor 1 is attached to, transmission member 7 intersecting with support plate surface 5s in a diagonal direction, transmission member 7 provided on rotating shaft 1a, first gear 9 that has first helical teeth 9a that mesh with transmission member 7, and is rotatably attached to support plate 5, first gear 9 rotating in a first direction by rotation of motor 1, and second gear 10 that has second helical teeth 10a, and is rotatably attached to support plate 5, second gear 10 rotating in synchronization with rotation of first gear 9 in a second direction that is opposite to the first direction.

More specifically, worm 7 as a transmission member is provided on rotating shaft 1a of motor 1, and motor 1 is attached to motor attachment portion 5b of support plate 5 with screws 2, worm 7 provided on rotating shaft 1a intersecting with support plate surface 5s of support plate 5 in the diagonal direction. Further, first gear 9 and second gear 10 are fixed to support plate 5 via rotating shaft pins 8 and retaining rings 12, worm 7 meshes with first helical teeth 9a of first gear 9, and first helical teeth 9a of first gear 9 mesh with second helical teeth 10a of second gear 10. Further, circuit board 3 (described later) for detecting a rotational position of second gear 10 is attached to support plate 5 with screws 4. When motor 1 rotates worm 7 in response to a pulse signal from an external circuit board (not shown), first gear 9 that meshes with worm 7 through first helical teeth 9a becomes rotatable in the first direction on support plate 5 by rotation of motor 1, and second gear 10 that meshes with first gear 9 through second helical teeth 10a becomes rotatable in the second direction opposite to the first direction in synchronization with the rotation of first gear 9 on support plate 5.

In the gear drive mechanism of the present disclosure, since worm 7 intersects with support plate surface 5s of support plate 5 in the diagonal direction to drive first gear 9, a volume of the gear drive mechanism can be reduced and a number of parts can be reduced. This makes it possible to reduce a weight and a cost of the gear drive mechanism and improve operating accuracy of the gear drive mechanism.

Gear drive mechanism 15 shown in a perspective view of FIG. 2 can be obtained by assembling the members shown in FIG. 1 excluding screws 11, first blade member 13 for dimming, and second blade member 14 for dimming.

In other words, dimming device 22 of the present disclosure can be obtained by attaching first blade member 13 and second blade member 14 to first gear 9 and second gear 10 with screws 11, respectively.

Further, as shown in FIG. 2, worm 7 meshes with first gear 9, first gear 9 meshes with second gear 10, that is, second gear 10 does not mesh directly with worm 7, so that the rotation of first gear 9 in the first direction causes second gear 10 to rotate in the second direction. This allows worm 7 to be easily operated by hand when it is necessary to manually rotate worm 7 to adjust positions of first gear 9 and second gear 10.

Although not shown, worm 7 may be provided between first gear 9 and second gear 10, worm 7 intersecting with support plate surface 5s of support plate 5 in the diagonal direction. That is, not only first gear 9 but also second gear 10 may mesh with worm 7, and rotation of motor 1 may cause second gear 10 to rotate in the second direction.

Next, as shown in FIGS. 1 and 2, support plate 5 is provided with retainer 5a for preventing worm 7 from falling off from rotating shaft 1a of motor 1. Specifically, worm 7 provided on rotating shaft 1a rotates together with rotating shaft 1a when rotating shaft 1a rotates, but when motor 1 is operated for a long time, there is a risk that worm 7 loosens and falls off from rotating shaft 1a. Providing retainer 5a on support plate 5 can prevent worm 7 from causing backlash and popping out when looseness occurs.

Further, retainer 5a is provided in inclination to support plate 5, facing a tip of worm 7 at a distance. In this case, it is preferable that retainer 5a is provided in a state where a plate surface of retainer 5a is inclined and is orthogonal to an axis of rotating shaft 1a. This can effectively prevent worm 7 from falling off.

It is preferable that retainer 5a is formed integrally with support plate 5 by punching support plate 5.

Further, as shown in FIG. 2, first gear 9 and second gear 10 are attached to an upper surface side that is one surface side of support plate 5, and central axes of first gear 9 and second gear 10 are perpendicular to support plate surface 5s of support plate 5. Worm 7 intersects with support plate surface 5s of support plate 5 in the diagonal direction. That is, an intersection angle between a central axis of worm 7 (i.e., the central axis of rotating shaft 1a of motor 1) and the central axes of first gear 9 and second gear 10 is an acute angle of a predetermined value.

In gear drive mechanism 15 of the present disclosure, the intersection angle forming the acute angle is provided in a range of 50° to 65°, preferably in a range of 55° to 60°, for example, more preferably about 57°.

By setting the intersection angle within the above-described angle range, the rotation of worm 7 can be transmitted to first gear 9 and second gear 10 favorably and efficiently, so that the gear drive mechanism secures sufficient driving force, and at the same time, the operating accuracy of the gear drive mechanism is improved.

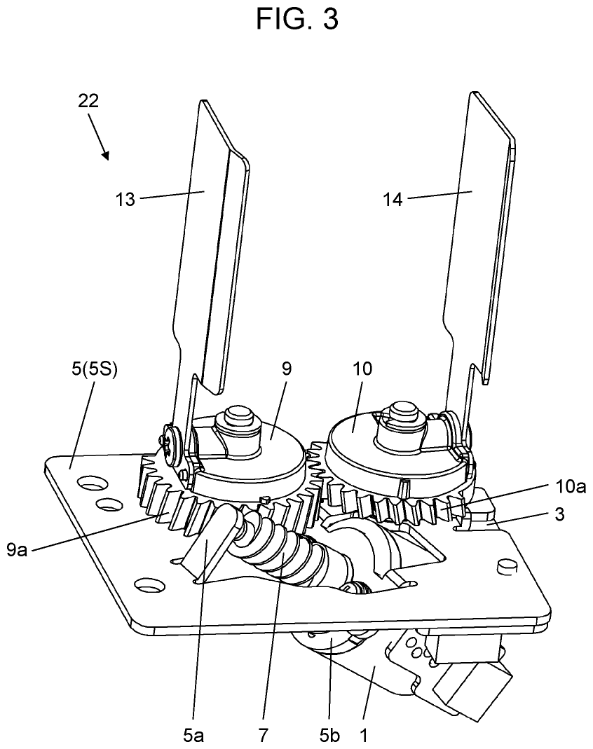

Hereinafter, the dimming device of the present disclosure will be described with reference to FIGS. 3 to 6. As described above, dimming device 22 of the present disclosure can be obtained by attaching, with screws 11, first blade member 13 for dimming and second blade member 14 for dimming to first gear 9 and second gear 10 in the gear drive mechanism shown in FIG. 2, respectively.

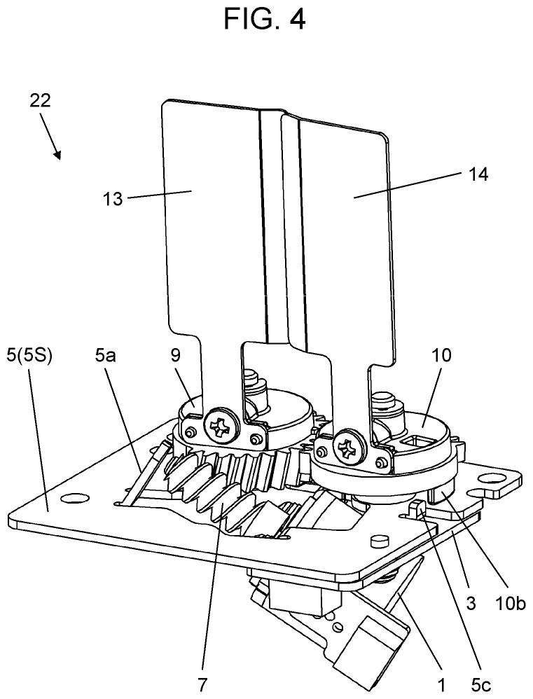

The dimming device of the present disclosure can adjust an amount of light flux from a light source device between a fully open state shown in FIG. 3 and a fully closed state shown in FIGS. 4 to 6.

Specifically, first blade member 13 for dimming is attached to first gear 9, and second blade member 14 for dimming is attached to second gear 10. When motor 1 rotates in forward and reverse directions, with this rotation, first gear 9 that meshes with worm 7 and second gear 10 that meshes with first gear 9 rotate in the forward and reverse directions. First blade member 13 and second blade member 14 rotate in forward and reverse directions as first gear 9 and second gear 10 rotate in the forward and reverse directions, respectively, and are changed between the fully open state shown in FIG. 3 and the fully closed state shown in FIGS. 4 to 6, the fully open state being a state where a plate surface of first blade member 13 and a plate surface of second blade member 14 face each other in parallel not to shield a light flux, the fully closed state being a state where the plate surface of first blade member 13 and the plate surface of second blade member 14 are located on a substantially same plane to completely shield the light flux.

That is, by controlling the rotation of motor 1, more specifically, by controlling motor 1 to repeat forward and reverse rotation, the amount of light flux to pass between first blade member 13 and second blade member 14 is adjusted.

For example, from the fully open state shown in FIG. 3, motor 1 rotates worm 7 in the forward direction in response to a pulse signal from the external circuit board to rotate first gear 9 in a counterclockwise direction, and to rotate second gear 10 in a clockwise direction, and this gradually changes first blade member 13 and second blade member 14 to a state where the light flux is shielded, and finally changes to the fully closed state shown in FIGS. 4 to 6 where the light flux is completely shielded. Further, from the fully closed state shown in FIGS. 4 to 6, motor 1 rotates worm 7 in the reverse direction in response to the pulse signal from the external circuit board to rotate first gear 9 in the clockwise direction, and to rotate second gear 10 in the counterclockwise direction, and this gradually changes first blade member 13 and second blade member 14 to a state where the light flux is passed, and finally changes to the fully open state shown in FIG. 3 where the light flux is completely passed.

In dimming device 22 of the present disclosure, gear drive mechanism 15 described above drives first blade member 13 and second blade member 14 to perform dimming, and thus same effects as those of gear drive mechanism 15 described above can be obtained.

More specifically, in dimming device 22 of the present disclosure, since worm 7 intersects with support plate surface 5s of support plate 5 in the diagonal direction to directly rotate first gear 9 and first blade member 13 is fixed directly to first gear 9, there is no transmission component other than first gear 9 between worm 7 and first blade member 13, and there is no necessity to provide other transmission components. As a result, a volume of the dimming device (gear drive mechanism) can be reduced, and a number of parts can be reduced. This makes it possible to reduce a weight and a cost of the dimming device (gear drive mechanism) and improve operating accuracy of the dimming device (gear drive mechanism).

In the dimming device of the present disclosure, spring 6 (FIG. 1) is provided between second gear 10 and support plate 5, and spring 6 always applies force in a direction where first blade member 13 and second blade member 14 are fully opened. Thereby, spring 6 can cancel the backlash between worm 7 and first gear 9, and between first gear 9 and second gear 10, and can stabilize opening and closing positions of first blade member 13 and second blade member 14 at the time of the forward and reverse rotation of motor 1.

Further, as shown in FIG. 4, protrusion 10b is provided on a lower surface of second gear 10 facing support plate 5, and correspondingly, protrusion 5c is integrally formed on support plate 5 by punching, and protrusion 10b and protrusion 5c are provided, facing each other.

Providing protrusions 10b and 5c as described above can prevent first gear 9 and second gear 10 from being further rotated after first blade member 13 and second blade member 14 are fully closed.

Although not shown, it goes without saying that first gear 9 may be provided with the above-mentioned protrusion, and further, first gear 9 and/or second gear 10 may be provided with a stopper portion that is engaged with support plate 5, and this stopper portion may prevent first gear 9 and second gear 10 from further rotating after first blade member 13 and second blade member 14 are fully opened.

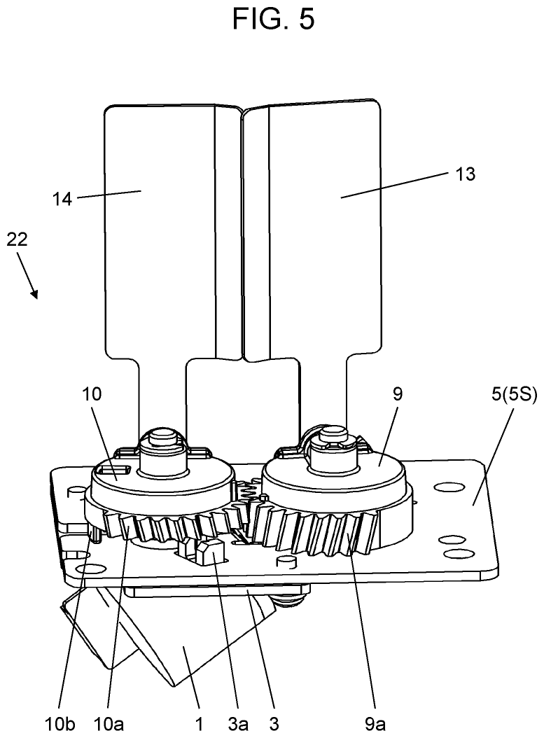

Further, as shown in FIG. 5, position sensor 3a provided in circuit board 3 is exposed on an upper surface of support plate 5. As a result, when first blade member 13 and second blade member 14 change from the fully closed state shown in FIG. 5 to the fully open state shown in FIG. 3, it can be detected that first blade member 13 and second blade member 14 are in the fully open state, based on whether or not protrusion 10b of second gear 10 is located in a recess of position sensor 3a.

Although not shown, it goes without saying that first gear 9 may be provided with a protrusion such as protrusion 10b described above, and position sensor 3a provided in circuit board 3 and exposed on the upper surface of support plate 5 may be used to thereby detect that first blade member 13 and second blade member 14 are in the fully open state as described above.

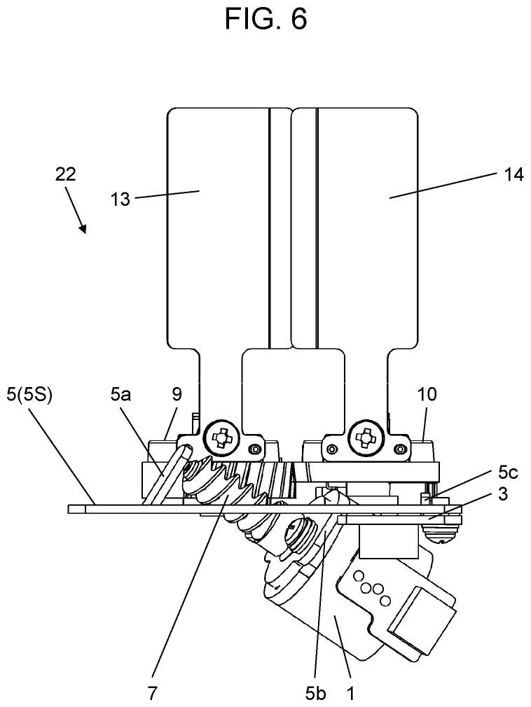

Further, as shown in FIG. 6, in support plate 5, motor attachment portion 5b for attaching motor 1 is provided on a lower surface side that is another surface side opposite to the upper surface side that is the one surface side where first gear 9 and second gear 10 are attached. Motor 1 is attached to motor attachment portion 5b in a state where worm 7 provided in rotating shaft 1a diagonally penetrates support plate 5. Further, circuit board 3 is provided on the lower surface side of support plate 5 that is the other side where motor attachment portion 5b is provided. That is, by causing worm 7 to diagonally intersect with support plate surface 5s of support plate 5, circuit board 3, and first gear 9 and second gear 10 are disposed on both the upper and lower surface sides of support plate 5, respectively. This can increase a degree of freedom of disposition of first gear 9 and second gear 10, and effectively prevent circuit board 3 from being irradiated with the light flux.

Finally, a projector of the present disclosure is an electronic device that modulates the light flux emitted from light source device 21 in response to an image signal and magnifies and projects the resultant light flux onto a projection screen 25 such as a screen. The projector includes optical block 20 including dimming device 22 described above, light source device 21 that emits the light flux, and optical modulation device 23 that modulates the light flux in response to the image signal, the light flux being dimmed by dimming device 22.

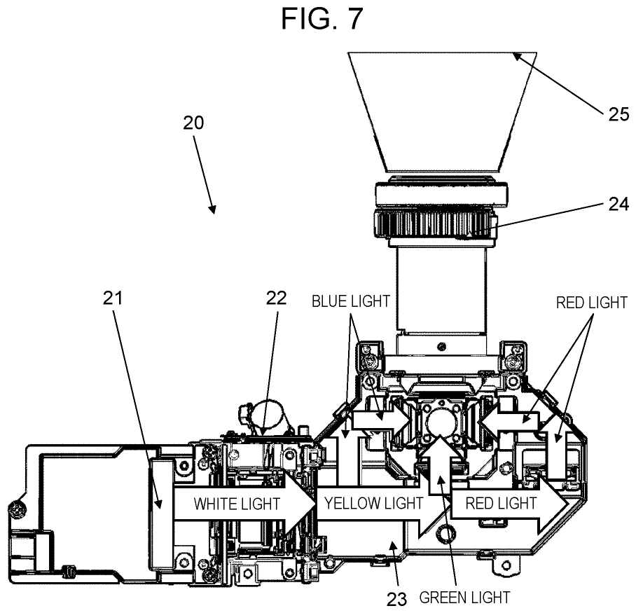

Specifically, as shown in FIG. 7, in the projector of the present disclosure, for example, white light is emitted from the light source device, and the dimming device shields or passes the white light in response to an input signal from a main circuit board in the projector (i.e., a pulse signal from an external circuit board). When the white light is passed, the white light is split and modulated by the optical modulation device into, for example, red light, blue light, green light, and yellow light, and finally, modulated light fluxes of these colors are projected on projection screen 25 via projection lens 24. FIG. 7 shows only optical block 20 of the projector, and does not show a power supply block, a cooling device, a control block, and the like provided inside the projector, and a housing for accommodating them.

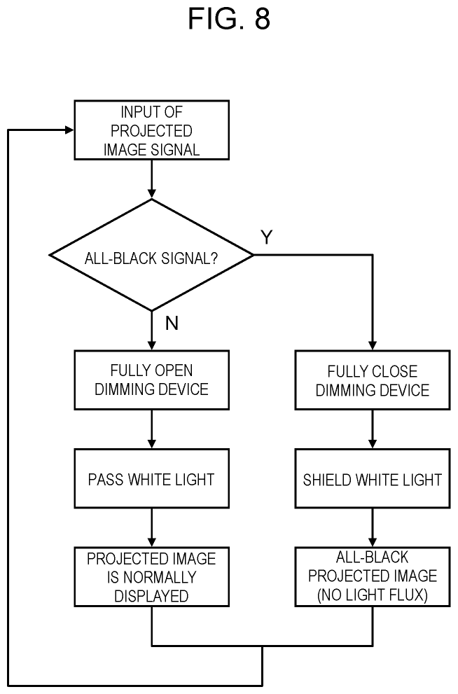

Hereinafter, an operating process of the projector of the present disclosure will be described in more detail with reference to a flowchart showing operation of the projector shown in FIG. 8.

Specifically, it is determined whether or not the input signal from the main circuit board in the projector is an all-black signal. If the input signal is the all-black signal (a determination result is “Y”), dimming device 22 is changed to the fully closed state to shield the white light from light source device 21, and this results in a state where a projected image becomes all-black with no light flux. On the other hand, if the input signal is not the all-black signal (the determination result is “N”), dimming device 22 is changed to the fully open state and passes the white light from light source device 21, and this results in a projected state where the projected image is normally displayed and projected.

The input signal from the main circuit board in the projector is not limited to the all-black signal. That is, it goes without saying that when it is necessary to control the amount of light flux passing through a lens in the projector, by controlling an opening and closing angle between first blade member 13 and second blade member 14 in the dimming device, the amount of light flux passing through the lens can be controlled. In other words, the opening and closing angle between first blade member 13 and second blade member 14 in the dimming device is controlled between the fully open state and the fully closed state in response to the input signal from the main circuit board in the projector. By controlling as described above, it is possible to control the amount of light flux passing through the lens, and thereby, a predetermined amount of light flux results in the projected image through the lens in the projector.

In the projector of the present disclosure, gear drive mechanism 15 described above drives first blade member 13 and second blade member 14 to perform dimming, so that the same effects as those of gear drive mechanism 15 described above can be obtained. The gear drive mechanism, the dimming device, and the projector of the present disclosure have been described above by the specific exemplary embodiment shown in FIGS. 1 to 8.

As is clear from the above description, in order to achieve the object of the disclosure of providing a gear drive mechanism capable of reducing the volume of the gear drive mechanism and reducing the number of parts, the present disclosure provides a gear drive mechanism including motor 1, worm 7 that is a transmission member provided on rotating shaft 1a of motor 1, support plate 5 that has support plate surface 5s, motor 1 being attached to the transmission member intersecting with support plate surface 5s in a diagonal direction, first gear 9 that has first helical teeth 9a that mesh with the transmission member, and is rotatably attached to support plate 5, first gear 9 rotating in a first direction by rotation of motor 1, and second gear 10 that has second helical teeth 10a, and is rotatably attached to support plate 5, second gear 10 rotating in synchronization with rotation of first gear 9 in a second direction that is opposite to the first direction.

According to the gear drive mechanism of the present disclosure, since the transmission member intersects with support plate surface 5s of support plate 5 in the diagonal direction to drive first gear 9, the volume of the gear drive mechanism can be reduced, and the number of parts can be reduced. This makes it possible to reduce the weight and the cost of the gear drive mechanism and improve operating accuracy of the gear drive mechanism.

It is preferable that second helical teeth 10a mesh with first helical teeth 9a, and by this meshing, second gear 10 rotates in the second direction by the rotation of first gear 9 in the first direction.

This allows the transmission member to be easily operated by hand when it is necessary to manually rotate the transmission member to adjust positions of first gear 9 and second gear 10.

It goes without saying that second helical teeth 10a may mesh with the transmission member, and by this meshing, second gear 10 may rotate in the second direction by the rotation of motor 1.

It is preferable that support plate 5 is provided with retainer 5a that prevents the transmission member from falling off from rotating shaft 1a.

It is more preferable that retainer 5a is provided in inclination to support plate 5, retainer 5a facing a tip of the transmission member at a distance.

As a result, retainer 5a can effectively prevent the transmission member from falling off and popping out when backlash occurs.

It is preferable that first gear 9 and second gear 10 are attached to one surface side of support plate 5, respective central axes of first gear 9 and second gear 10 being perpendicular to support plate surface 5s of support plate 5, support plate 5 has motor attachment portion 5b for attaching motor 1 on another side opposite to the one side, and motor 1 is attached to motor attachment portion 5b, the transmission member diagonally penetrating support plate 5, the transmission member being provided on rotating shaft 1a.

That is, by causing the transmission member to intersect with support plate surface 5s of support plate 5 in the diagonal direction, circuit board 3 for detecting the rotational position of second gear 10, and first gear 9 and second gear 10 can be provided on both the upper and lower surfaces of support plate 5, respectively. This can increase the degree of freedom in disposition of first gear 9 and second gear 10 and effectively prevent circuit board 3 from being irradiated with the light flux.

Further, in the present disclosure provides dimming device 22 including gear drive mechanism 15 described above, first blade member 13 for dimming provided in first gear 9, and second blade member 14 for dimming provided on second gear 10, wherein dimming device 22 adjusts an amount of light flux passing between first blade member 13 and second blade member 14 by controlling rotation of motor 1.

Further, the present disclosure provides a projector including dimming device 22 described above, light source device 21 that emits a light flux, and optical modulation device 23 that modulates, in response to an image signal, the light flux dimmed by dimming device 22.

According to dimming device 22 and the projector of the present disclosure, gear drive mechanism 15 described above drives first blade member 13 and second blade member 14 to perform dimming, and thus the same effects as those of gear drive mechanism 15 described above can be obtained.

While as described above, the present disclosure has sufficiently described the preferred exemplary embodiment with reference to the drawings, those skilled in the art will obviously make appropriate modifications or changes based on the above exemplary embodiment. These modifications or changes are considered to be included in the scope of protection of the present disclosure if they do not deviate from the gist of the present disclosure.

The present disclosure can be applied to a gear drive mechanism, a dimming device including the gear drive mechanism, and a projector including the dimming device.

What is claimed is:

1. A gear drive mechanism comprising:
a motor;
a transmission member provided on a rotating shaft of the motor;
a support plate that has a support plate surface, and to which the motor is attached to case the transmission member to intersect with the support plate surface in a diagonal direction;
a first gear that has first helical teeth that mesh with the transmission member and is rotatably attached to the support plate, the first gear rotating in a first direction by rotation of the motor; and
a second gear that has second helical teeth and is rotatably attached to the support plate, the second gear rotating in synchronization with rotation of the first gear in a second direction opposite to the first direction.

2. The gear drive mechanism according to claim 1, wherein the second helical teeth mesh with the first helical teeth to cause the second gear to rotate in the second direction by the rotation of the first gear in the first direction.

3. The gear drive mechanism according to claim 1, wherein the second helical teeth mesh with the transmission member to cause the second gear to rotate in the second direction by the rotation of the motor.

4. The gear drive mechanism according to claim 1, wherein the support plate is provided with a retainer that prevents the transmission member from falling off from the rotating shaft.

5. The gear drive mechanism according to claim 4, wherein the retainer is provided in inclination to the support plate surface, the retainer facing a tip of the transmission member at a distance.

6. The gear drive mechanism according to claim 1, wherein
the first gear and the second gear are attached to one side of the support plate, respective central axes of the first gear and the second gear being perpendicular to the support plate surface,
the support plate has a motor attachment portion for attaching the motor on another side opposite to the one side, and
the motor is attached to the motor attachment portion, the transmission member diagonally penetrating the support plate surface, the transmission member being provided on the rotating shaft.

7. A dimming device comprising:
the gear drive mechanism according to claim 1;
a first blade member for dimming provided on the first gear; and
a second blade member for dimming provided on the second gear, wherein the dimming device adjusts an amount of light flux passing between the first blade member and the second blade member by controlling rotation of the motor.

8. A projector comprising:
the dimming device according to claim 7;
a light source device that emits a light flux; and
an optical modulation device that modulates, in response to an image signal, the light flux dimmed by the dimming device.
